(19) United States
(12) Patent Application Publication
(10) Pub. No.: US 2004/0091269 A1
(43) Pub. Date: May 13, 2004

(54) Optical free space signalling system

(76) Inventors: Alan Edward Green, Ickleton (GB); Euan Morrison, Ickleton (GB)

Correspondence Address: FOGG AND ASSOCIATES, LLC, P.O. BOX 581339, MINNEAPOLIS, MN, 55458-1339, US

(21) Appl. No.: 10/332,796

(22) PCT Filed: Jul. 11, 2001
(86) PCT No.: PCT/GB01/03113

(30) Foreign Application Priority Data
Jul. 11, 2000 (GB) 0017048.0

(51) Int. Cl. H04B 10/00; G02B 26/00

(52) U.S. Cl. 398/130

(57) ABSTRACT

There is described an optical free space signalling system having an optical device comprising a lens and a plurality of optical elements. A beam deflector for deflecting light beams is provided in an optical path between the lens and the plurality of optical elements. The bean deflector has a plurality of beam deflecting elements with each beam deflecting element being associated with a respective optical element and being operable to deflect a principal light ray passing through the lens so that the principal light ray is substantially perpendicular to the associated optical element. The optical device has particular, but not exclusive, relevance to retro-reflecting systems.

This invention relates to a signalling system and components thereof. In particular, this invention relates to a signalling method and apparatus in which data is conveyed by modulating a free-space light beam.

International Patent Application WO 98/35328, the whole contents of which are incorporated herein by reference, describes a point-to-multipoint communication system using free-space light beams. In particular, WO 98/35328 describes a system in which a plurality of user stations (provided, for example, on respective houses in a street) emit unmodulated light beams which are directed to a local distribution node (provided, for example, on a post in the street). At the local distribution node, each of the incoming light beams is modulated in accordance with a data signal by a respective modulator element of an array of modulator elements which are individually drivable, and is reflected back to the user station from which it originated. At the user station, the modulated light beam is detected and the data signal is regenerated.

In the local distribution nodes of the system described in WO 98/35328, the light from each user station is retro-reflected by a substantially planar reflector which is located in the back focal plane of a telecentric lens in order to direct the light back to the originating user station. By using a telecentric lens, the principal ray from each of the user stations passing through the telecentric lens (i.e. the ray which passes through the centre of the entrance pupil of the telecentric lens) is incident perpendicular to the reflective surface of the reflector and therefore the reflector reflects the incident light back along its path of incidence. In this way, the reflector and telecentric lens form a retro-reflector. Another advantage of using a telecentric lens is that light beams from different user stations are incident on their respective modulator elements at the same angle, irrespective of the positioning of the user stations within the field of view of the telecentric lens. In this way, the efficiency of modulation (i.e. the modulation depth), which generally depends upon the angle at which the light beam hits the modulator element, is approximately constant for the light beams from all the user stations.

In the user stations of the system described in WO 98/35328, a laser diode outputs a light beam which is collimated and then transmitted through a beam splitter before being expanded by a telescope arrangement, and modulated light reflected back from the local distribution node passes back through the telescope arrangement and is reflected by the beam splitter onto a photodiode. A problem with this arrangement is that a portion of the light emitted by the laser diode and transmitted through the beam splitter is reflected back to the beam splitter by the optical surfaces of the telescope arrangement which then reflects the light onto the photodiode, resulting in a large steady-state background level which significantly reduces the signal to noise ratio when recovering the data conveyed by the modulated light beam reflected back from the local distribution node and can lead to saturation of the photodiode.

In accordance with an aspect of the invention, there is provided an optical device comprising a lens and a plurality of optical elements. Beam deflecting means are positioned in an optical path between the lens and the plurality of optical elements which deflect a plurality of principal rays passing through the lens so that they are optically parallel to the optical axis of the lens. In this way, the lens and the beam deflecting means form an alternative to the telecentric lens arrangement described in WO 98/35328.

According to another aspect of the invention, there is provided a signalling device for a free-space retro-reflecting signalling system comprising a light emitter and a light detector. Separate lens systems are provided for the light emitter and the light detector, relying on divergence of the emitted light beam to cause light to be directed through the lens system for the light detector. In this way, the reflections of emitted light off components of the lens systems which are incident on the light detector are reduced. Further, the lens systems can be separately optimised in accordance with the differing requirements associated with a light emitter and a light detector.

According to a further aspect of the invention, there is provided a signalling device for a free-space retro-reflecting signalling system comprising a light modulator and a light detector. Separate lens systems are provided for the light modulator and the light detector. In this way, the lens systems can be separately optimised in accordance with the differing requirements associated with a light modulator and a light detector.

Exemplary embodiments of the invention will now be described with reference to the accompanying drawings in which:

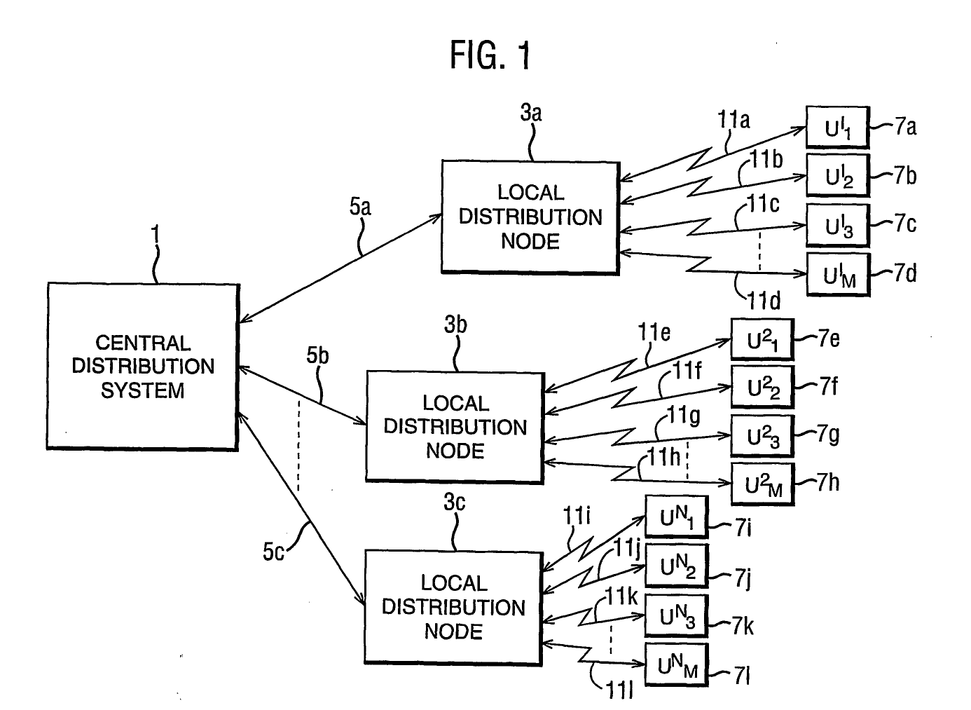

FIG. 1 is schematic diagram of a point-to-multipoint communication system for distributing data between a central distribution system and a plurality of user stations;

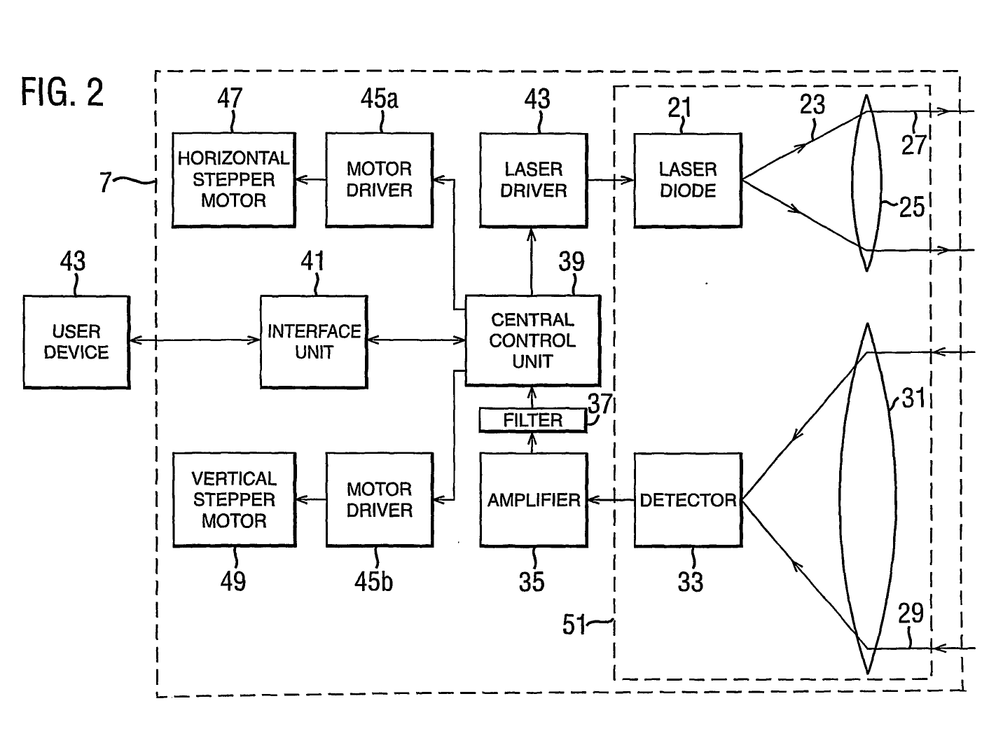

FIG. 2 is schematic diagram of a user station and associated user device which form part of the data distribution system shown in FIG. 1;

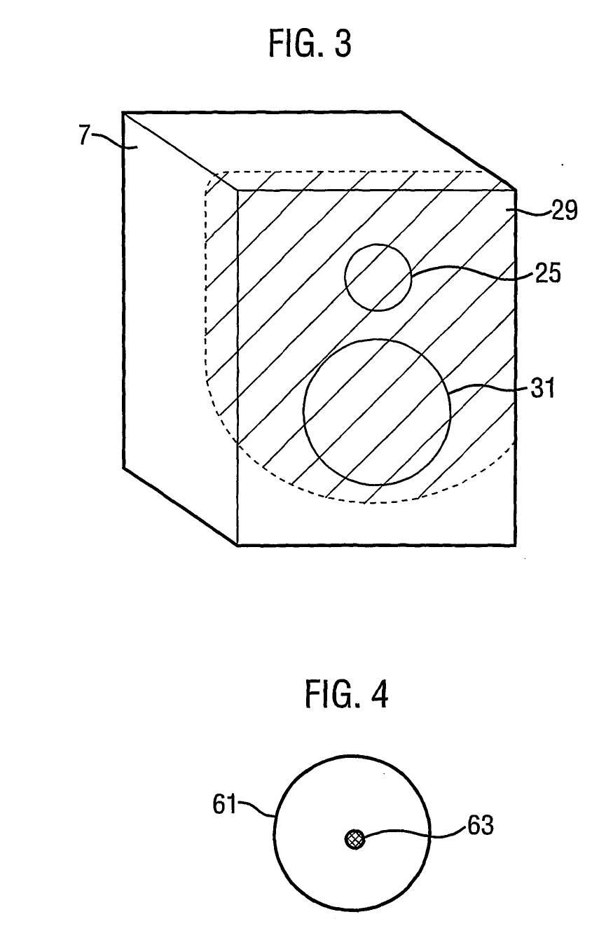

FIG. 3 shows a perspective view of the user station illustrated in FIG. 2;

FIG. 4 is a schematic diagram showing the detection surface of a detector forming part of the user terminal illustrated in FIG. 2;

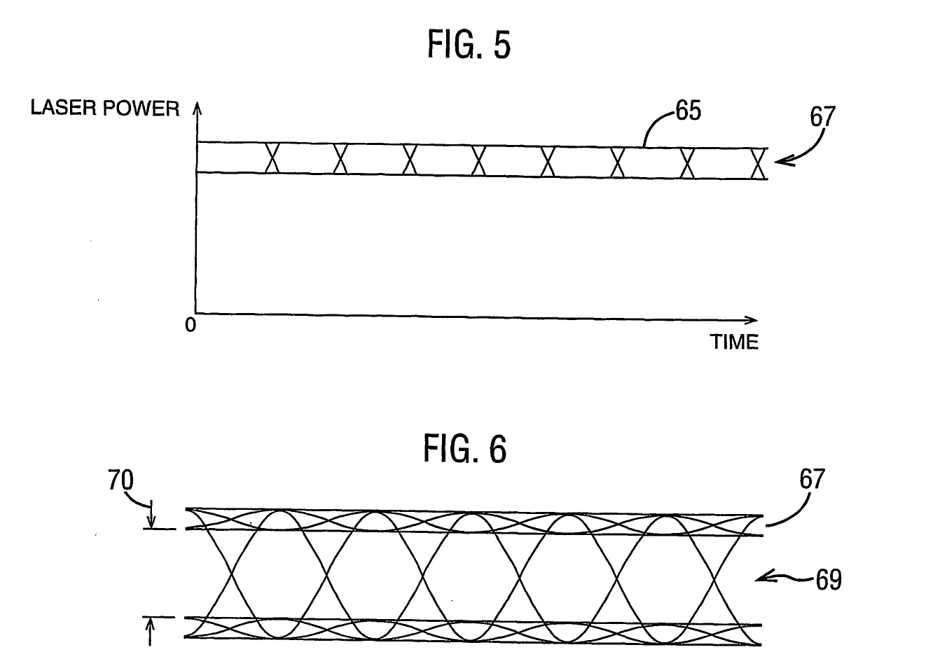

FIG. 5 is a plot illustrating the way that the power of a laser beam emitted by the user station is varied to achieve a small signal modulation for uplink data transmitted from the user device to the local distribution node;

FIG. 6 is an eye diagram schematically illustrating the effect of the small signal modulation on the downlink data transmitted from the local distribution node to the user device;

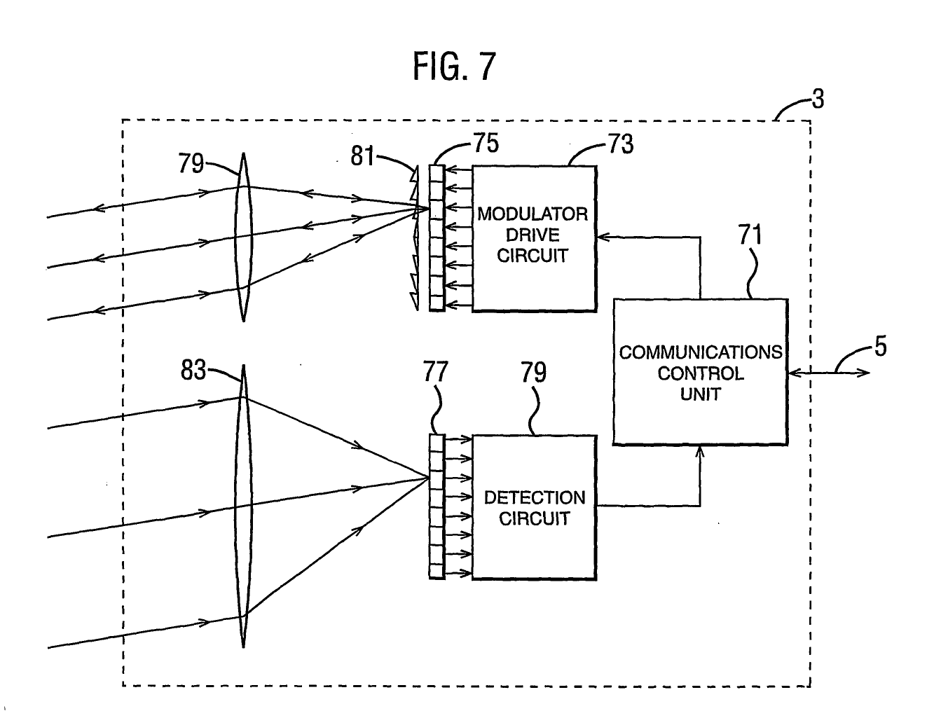

FIG. 7 is a schematic diagram of a local distribution node which forms part of the data distribution system illustrated in FIG. 1;

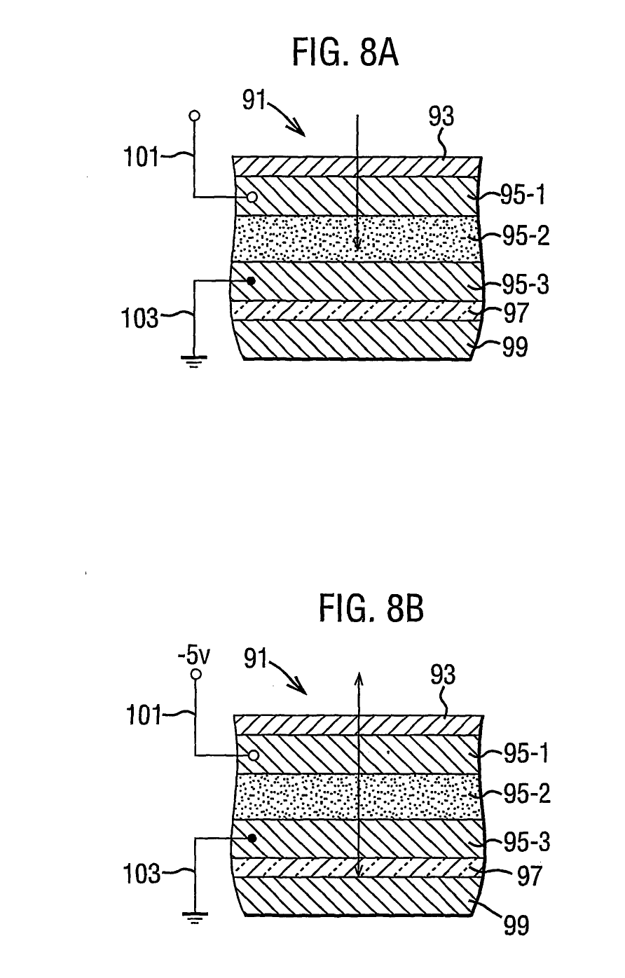

FIG. 8A is a cross-sectional view of one modulator of a modulator array which forms part of the local distribution node illustrated in FIG. 7 in a first operational mode when no DC bias voltage is applied to the electrodes thereof;

FIG. 8B is a cross-sectional view of one modulator of the modulator array which forms part of the local distribution node illustrated in FIG. 7 in a second operational mode when a bias voltage is applied to the electrodes thereof;

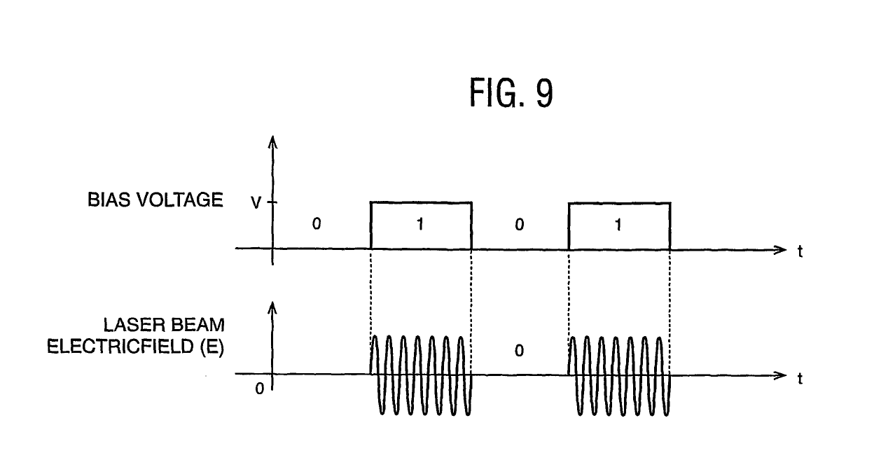

FIG. 9 is a signal diagram which schematically illustrates the way in which the light incident on the modulator shown in FIGS. 8A and 8B is modulated in dependence upon the bias voltage applied to the pixel electrodes;

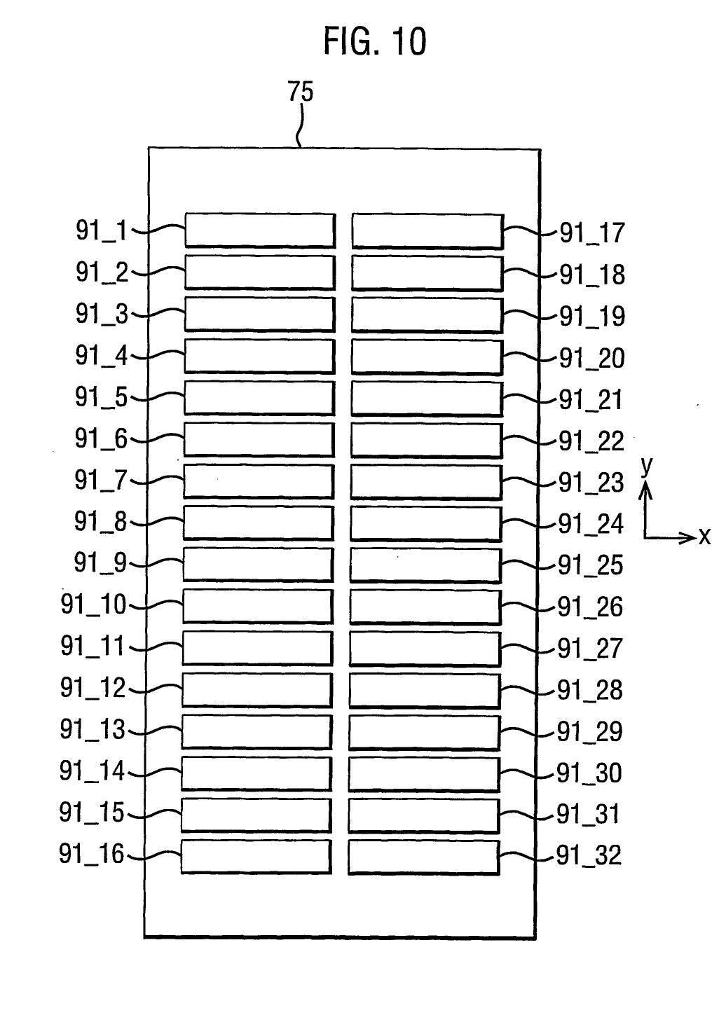

FIG. 10 is a schematic diagram of a surface of the modulator array forming part of the local distribution node shown in FIG. 7;

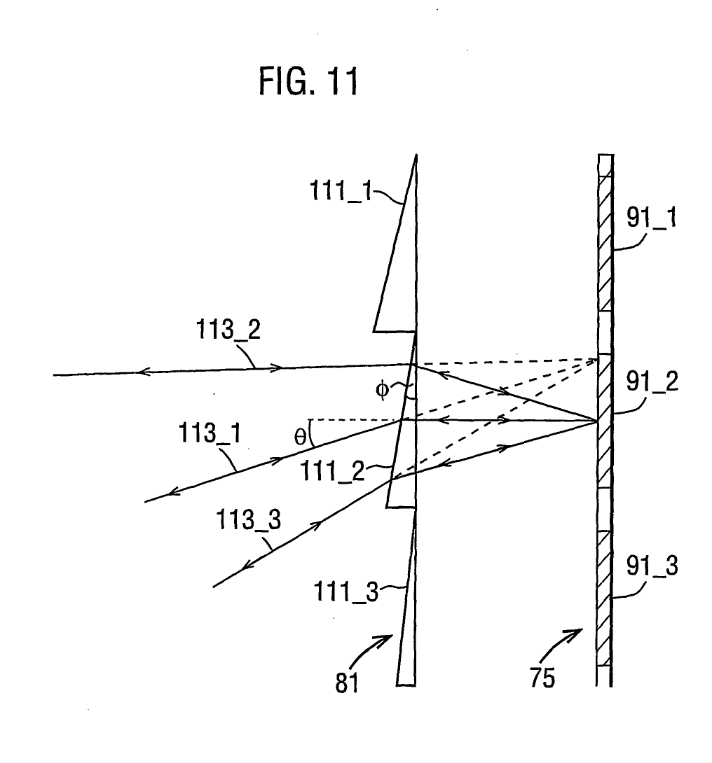

FIG. 11 schematically shows part of a wedge array and of the modulator array which form part of the local distribution node illustrated in FIG. 7;

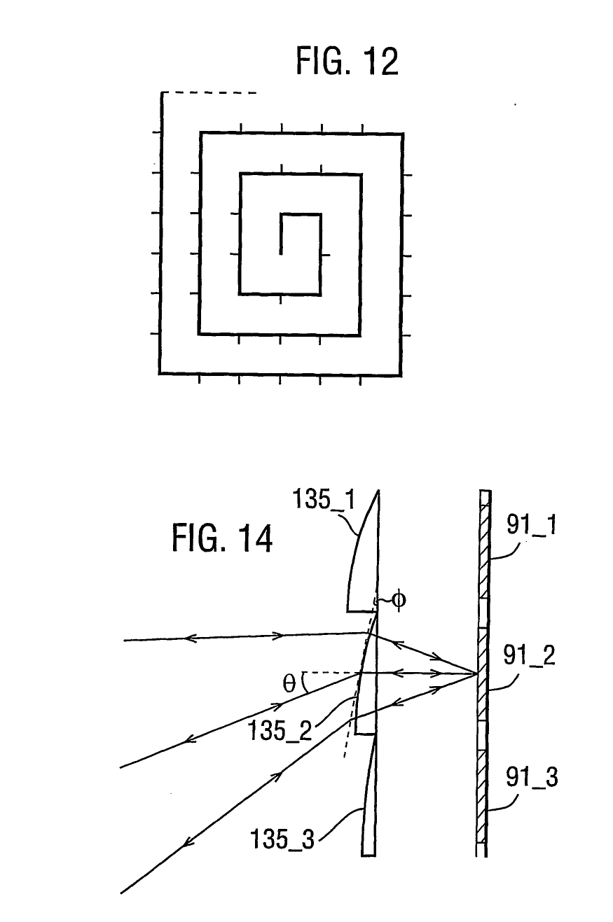

FIG. 12 schematically shows a search pattern for aligning a light beam emitted from the user station shown in FIG. 2 with the local distribution node shown in FIG. 7 to establish a communications link;

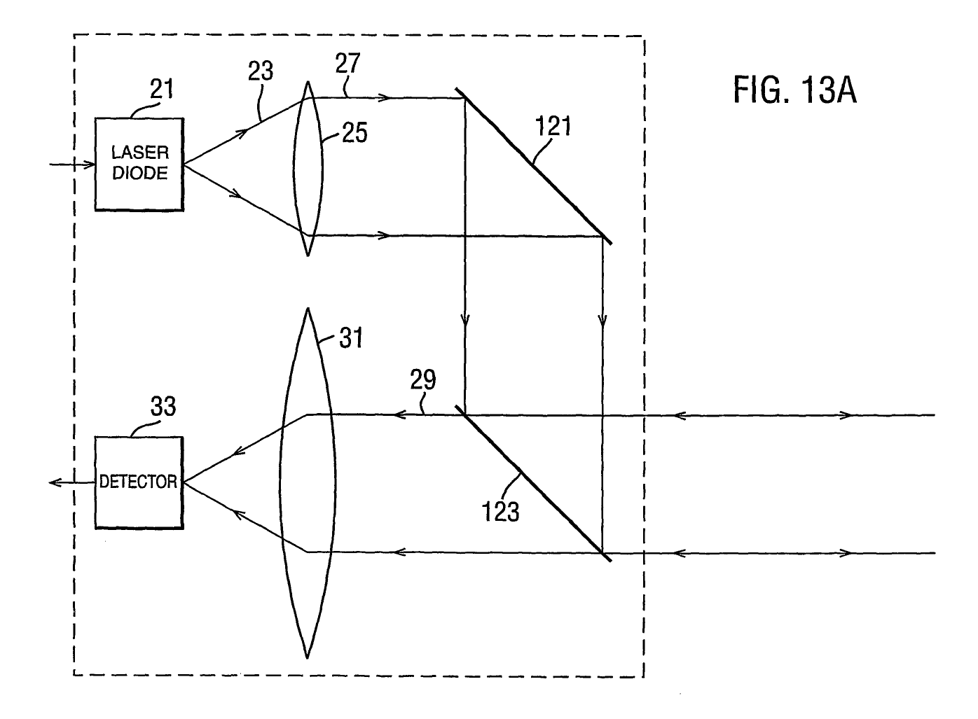

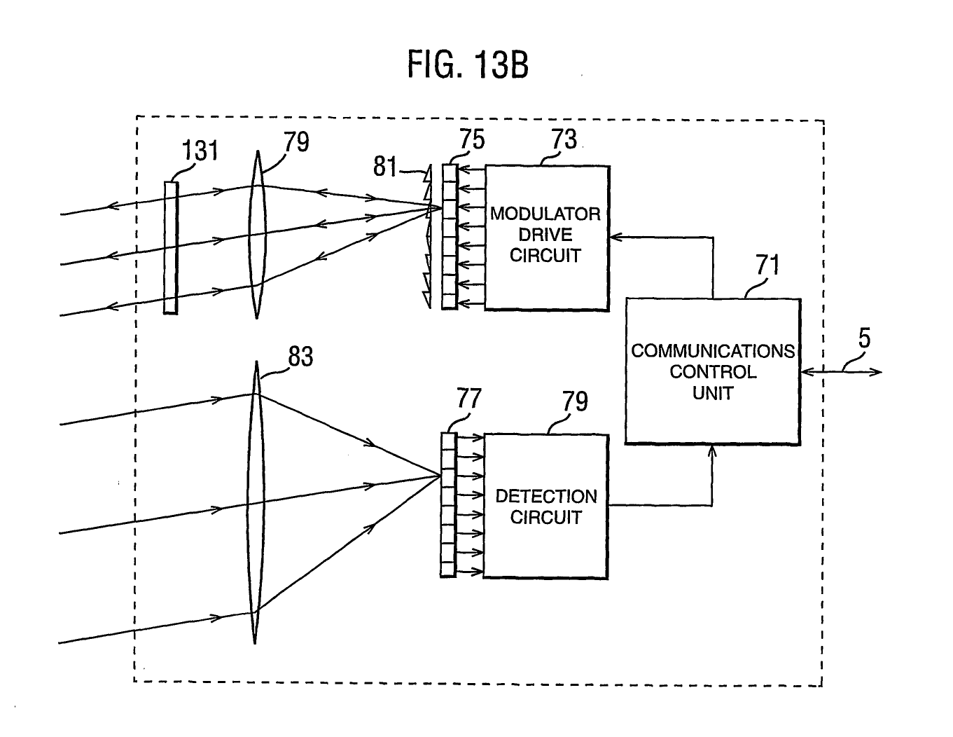

FIG. 13A schematically shows an alternative optical assembly for the user station illustrated in FIG. 2;

FIG. 13B schematically shows an alternative local distribution node to the local distribution node illustrated in FIG. 7;

FIG. 14 schematically shows part of an alternative wedge array and of the modular array for the local distribution node shown in FIG. 7;

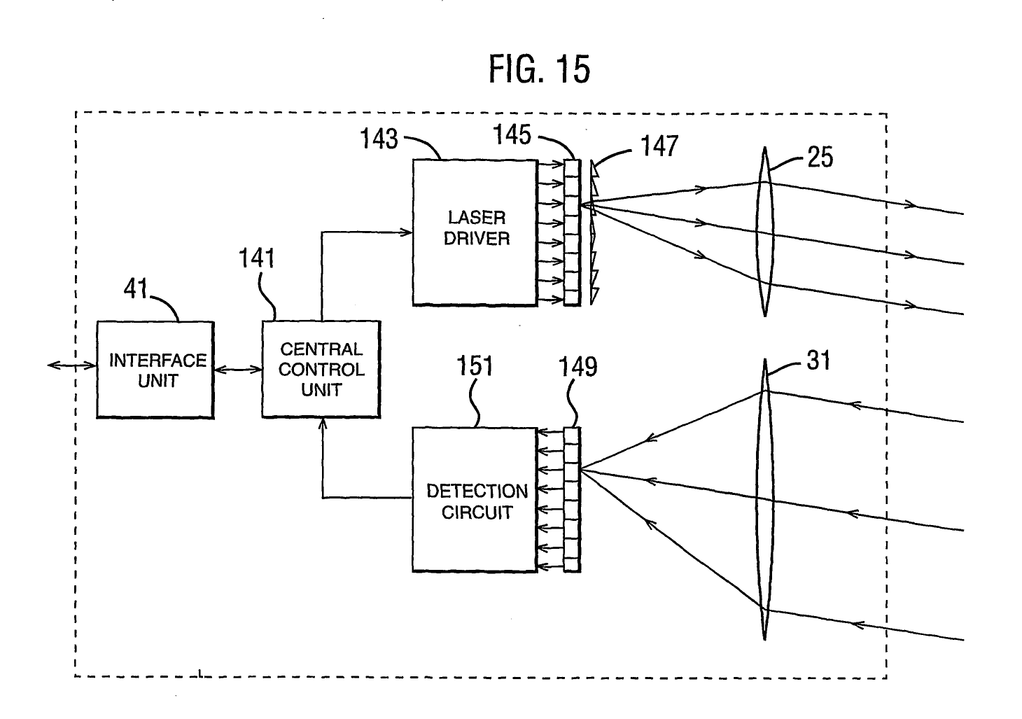

FIG. 15 schematically shows the main components of an alternative user station for the data distribution system illustrated in FIG. 1; and

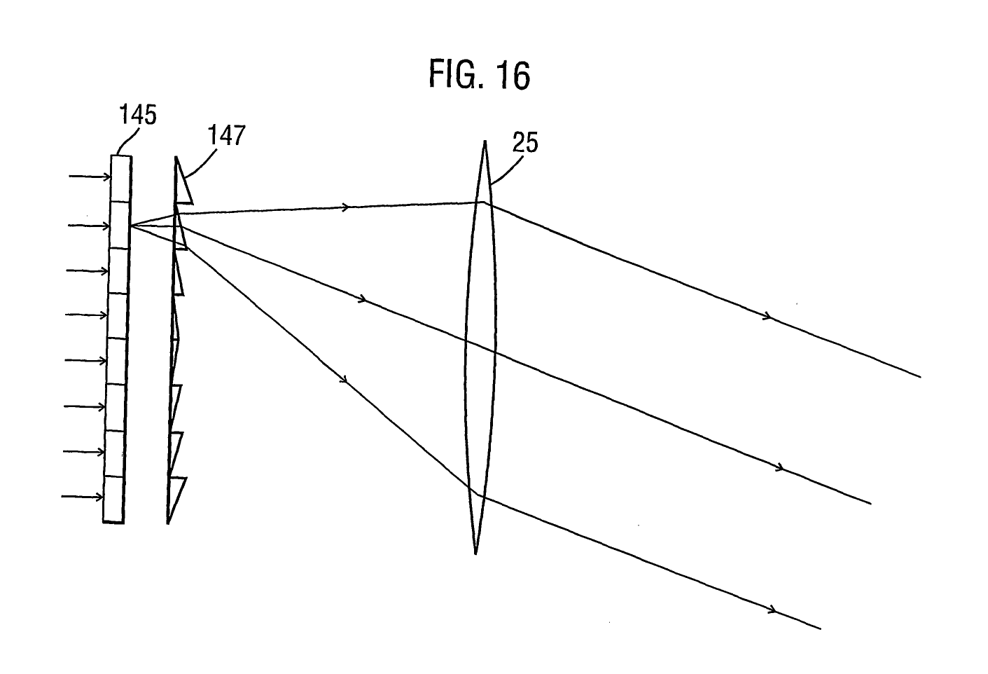

FIG. 16 schematically shows an enlarged portion of FIG. 15.

FIG. 1 schematically illustrates a data distribution system which employs a point-to-multipoint signalling system to transmit data to and receive data from a plurality of user stations. As shown, the data distribution system comprises a central distribution system 1 which transmits optical data signals to and receives optical data signals from a plurality of local distribution nodes 3a to 3c via respective optical fibres 5a to 5c.

At the local distribution node 3a, data streams received from the central distribution system 1 are transmitted to respective users stations 7a to 7d and data for transmission to the central distribution 1 is received from the user stations 7a to 7d using free-space optical links 11a to 11d, i.e. optical links in which light is not guided along an optical fibre path. Similarly, data is transmitted between the local distribution node 3b and user stations 7e to 7h using free-space optical links 11e to 11h, and data is transmitted between the local distribution node 3c and user stations 7i to 7l using free-space optical links 11i to 11l. Each of the user stations 7 is connected to at least one user device (not shown). In this embodiment, the user devices include a television set (not shown), which transmits channel information to the central distribution system 1 and in response receives corresponding television signals, and a computer system (not shown), which access the internet via the central distribution system.

In this embodiment, each user station 7 emits a low divergence, free-space light beam which is modulated in accordance with data to be conveyed to the local distribution node and directed at the corresponding local distribution node 3. Each local distribution node 3 has a plurality of modulating elements (not shown in FIG. 1) which modulate and retro-reflect the light beams from respective user stations 7 to convey data from the local distribution node 3 to the user station 7.

FIG. 2 schematically illustrates in more detail the main components of one of the user stations 7 of the data distribution system shown in FIG. 1. As shown, the user station 7 comprises a laser diode 21 which outputs a beam 23 of coherent light. In this embodiment, the user stations 7 are designed so that they can communicate with a local distribution node 3 within a range of 200 metres with a link availability of 99.9.%. To achieve this, the laser diode 21 is a 50 mw laser diode which outputs a laser beam having a wavelength of 850 nm.

The output light beam 23 is passed through a lens 25, hereafter called the collimating lens 25, which reduces the angle of divergence of the light beam 23 to form a substantially low divergence light beam 27. The divergence of the low divergence light beam can be varied by varying the distance between the collimated lens 25 and the light source 21. However, those skilled in the art will appreciate that the low divergence light beam 27 can not be perfectly collimating due to diffraction at the emitting aperture of the laser diode. In this embodiment, the collimating lens 25 is a low aberration lens, so that the low divergence beam 27 has a relatively uniform wavefront, with a 50 mm diameter and an F-number which is just large enough to collect all the light emitted by the laser diode 21.

Although the divergence of the light beam 27 is low, the size of the light beam 29 incident on the user station 7 after reflection by the local distribution node 3 is significantly larger than that of the low divergence light beam 27 leaving the user station 7. In this embodiment, as shown in FIG. 3, the beam size of the received light beam 29 is large enough to encompass a lens, hereafter called the downlink detection lens 31, which is provided adjacent to the collimating lens 25. In this embodiment, the entrance pupils of the collimating lens 25 and the downlink detection lens 31 are located in the same plane.

Returning to FIG. 2, in which for clarity only the portion of the received light beam 29 incident on the downlink detection lens 31 is shown, the downlink detection lens 31 focusses light from the received light beam 29 onto a detector 33, which in this embodiment is an avalanche photodiode. The downlink detection lens 31 has a diameter of 100 mm but is not required to be of as high quality as the collimating lens 25 because its primary purpose is simply to direct as much light as possible onto the detector 33. FIG. 4 schematically shows the detection surface 61 of the detector 33 and the light spot 63 formed by the downlink detection lens 31 focussing light from the received light beam 29. In this embodiment, the diameter of the detection surface 61 is 500 μm whereas the diameter of the light spot 63 is approximately 50 μm.

The detector 33 converts the received light beam into a corresponding electrical signal which varies in accordance with the modulation provided at the local distribution node 3. The electrical signal is amplified by an amplifier 35 and then filtered by a filter 37. The filtered signals are input to a central control unit 39 which performs a conventional clock recovery and data retrieval operation to regenerate the data from the central distribution system 1. The retrieved data is then passed to an interface unit 41 which is connected to the user device 43.

The interface unit 41 also receives data from the user device 43 and inputs the received data to the central control unit 39, which generates an appropriate message for transmittal to the central distribution system 1 via the local distribution node 3. This message is output to a laser driver 43 which modulates the light beam 23 output by the laser diode 21 in accordance with the message. In this embodiment, the laser driver 43 applies a small signal modulation to the light beam 23 output by the laser diode 21. FIG. 5 illustrates this modulation and shows the CW laser level 65 and the small signal modulation 67 applied to it. Due to the asymmetric path loss of a retro-reflecting system, the small signal modulation concept can be used to provide a “full” bandwidth uplink channel. As those skilled in the art will appreciate, this uplink modulation data will then become an additional noise source for the down link data. This is illustrated in FIG. 6 which shows an eye diagram for the downlink data 69, which includes the interfering uplink data 67, and the consequent reduction in the noise margin 70. However, if the uplink modulation depth is kept sufficiently low, then both the uplink and the downlink can operate with equal bandwidth. In this embodiment, the uplink modulation depth is approximately 3% of the CW laser level. Further details of this small signal modulation can be found in International Patent Application WO 01/05071, the whole contents of which are incorporated herein by reference.

Returning to FIG. 2, the central control unit 39 is also connected to a first motor driver 45a for supplying drive signals to a horizontal stepper motor 47, and to a second motor driver 45b for supplying drive signals to a vertical stepper motor 49. In this embodiment, the laser diode 21, the collimating lens 25, the detector 33 and the downlink detection lens 31 are mounted together to form a single optical assembly 51, and the horizontal stepper motor 47 is operable to rotate the optical assembly 51 about a vertical axis so that the collimating light beam 27 moves within a horizontal plane and the vertical stepper motor 49 is operable to rotate the optical assembly 51 about a horizontal axis so that the collimating light beam 27 moves in a vertical plane. In this way, the direction of the emitted light beam can be varied.

FIG. 7 schematically illustrates the main components of one of the local distribution nodes 3. As shown, the local distribution node, 3 comprises a communications control unit 71 which receives optical signals transmitted along the optical fibre 5 conveying data from the central distribution system and regenerates the conveyed data from the received optical signals. The communications control unit 71 generates control signals in accordance with the conveyed data which are output to a modulator drive circuit 73 which in turn supplies corresponding drive signals to a modulator array 75. In this embodiment, the modulator elements of the modulator array 75 are individually addressable by the modulator drive circuit 73, with the drive signals output by the modulator drive circuit 73 varying the reflectivity of the modulator elements.

In this embodiment, the modulator array 75 comprises a two-dimensional planar integrated array of Quantum Confined Stark Effect (QCSE) devices (which are sometimes also referred to as Self Electro-optic Devices or SEEDs). FIG. 8A schematically illustrates the cross-section of one of the QCSE devices 91. As shown, the QCSE device 91 comprises a transparent window 93 through which the light beam from the appropriate user station 7 passes, followed by three layers 95-1, 95-2, 95-3 of Gallium Arsenide (GaAs) based material. Layer 95-1 is a p-conductivity type layer, layer 95-2 is an intrinsic layer having a plurality of Quantum wells formed therein, and layer 95-3 is an n-conductivity type layer. Together, the three layers 95 form a p-i-n diode. As shown, the p-conductivity type layer 95-1 is connected to an electrode 101 and the n-conductivity type layer 95-3 is connected to a ground terminal 103. A reflective layer 97, in this embodiment a Bragg reflector, is provided beneath the n-conductivity type layer 95-3, and a substrate layer 99 is provided beneath the reflective layer 97.

In operation, the light beam from the user station 7 passes through the window 93 into the Gallium Arsenide based layers 95. The amount of light absorbed by the intrinsic layer 95-2 depends upon the DC bias voltage applied to the electrode 101. Ideally, when no DC bias is applied to the electrode 101, as illustrated in FIG. 8A, the light beam passes through the window 93 and is totally absorbed within the intrinsic layer 95-2. Consequently, when there is no DC bias voltage applied to the electrode 101, no light is reflected back to the corresponding user station 7. On the other hand, when a DC bias voltage of approximately −5 volts is applied to the electrode 101, as illustrated in FIG. 8B, the light beam from the corresponding user station 7 passes through the window 93 and the Gallium Arsenide based layers 95 and is reflected by the reflecting layer 97. Therefore, by changing the bias voltage applied to the electrode 101 in accordance with the drive signals from the modulator drive circuit 73, the QCSE modulator 91 amplitude modulates the received light beam and reflects the modulated light beam back to the user station 7.

In the ideal case, as illustrated in FIG. 9, a zero voltage bias, resulting in no reflected light, is applied to the electrode 101 to transmit a binary 0 and a DC bias voltage of −5 volts is applied to the electrode 101, resulting in the light from the user station 7 being reflected back from the QCSE device 91, to transmit a binary 1. Typically, however, the QCSE modulator 91 will reflect 70% of the light beam when no DC bias is applied to the electrode 101 and 95% of the light beam when −5 volts DC bias is applied to the electrode 101. Therefore, in practice, there will only be a difference of about 25% between the amount of light which is detected at the user station 7 when a binary 0 is transmitted and when a binary 1 is transmitted.

The amount of the received light beam absorbed by the intrinsic layer 95-2 can be increased by adding additional Quantum Wells to increase the depth of the intrinsic layer 95-2. However, if the depth of the intrinsic 95-2 is increased, then a higher voltage must be applied to the electrode 101 in order to produce the required electric field across the intrinsic layer 95-2 for allowing light to pass through the intrinsic layer 95-2. There is, therefore, a trade-off between the absorptivity of the intrinsic layer 95-2 and the voltage applied to the electrode 101.

By using the QCSE modulators 91, modulation rates of the individual modulator cells in excess of a Gigabit per second can be achieved.

FIG. 10 shows the surface of the modulator array 75 used in this embodiment. As shown, the modulator array 75 is a two-dimensional array with sixteen modulator elements 91 provided in a Y-direction and two modulator elements 91 provided in a X-direction perpendicular to the Y-direction. Those skilled in the art will appreciate that, by having only two modulators in the X-direction, the fabrication of the modulator array 75 is greatly simplified because the modulator elements 91 can be addressed from the sides of the array.

In this embodiment, each modulator element 91 has a length of approximately 1 mm in the X-direction and a width of approximately 100 μm in the Y-direction. This layout has been selected to match the likely distribution of users within a building having many floors. In particular, the modulator array 75 is aligned so that the X-direction corresponds to the horizontal direction on the building and the Y-direction corresponds to the vertical direction on the building, and less modulator elements 91 are provided in the X-direction than in the Y-direction because the users are expected to be predominantly distributed in the Y-direction. The length of the modulator elements 91 in the X-direction is made longer than the width in the Y-direction to ensure adequate coverage of the sides of the building.

The local distribution node 3 also comprises a detector array 77 having a plurality of light detecting elements. Each detecting element converts incident light from a respective user station 7 into a corresponding electrical signal which is input to a detection circuit 79. In the detection circuit 79, the electrical signals from the detector array are amplified, and then the detection circuit 79 performs conventional clock retrieval and data regeneration processing to recover message data from the user stations 7. The recovered message data from all of the user stations 7 is then output to the communications control unit 71 which transmits the message data to the central distribution system I as optical signals along the optical fibre 5.

As shown in FIG. 7, separate optical systems are provided for the modulator array 75 and the detector array 77. In particular, the modulator array 75 is located substantially within the back focal plane of a lens, hereafter called the modulator lens 79. As those skilled in the art will appreciate, the modulator lens 79 directs a low-divergence light beam received from a user station towards a point within its back focal plane whose position depends upon the angle of incidence of the received light beam. In other words, the modulator lens 79 maps different directions within its field of view to different positions on the modulator array. In this way, the modulator array is able to modulate and reflect light beams from a plurality of user stations 7 positioned in different locations within the field of view of the modulator lens 79.

In this embodiment, a wedge array 81 is provided to deflect the light beams from the user stations 7 transmitted through the modulator lens 79 so that the principal rays are incident perpendicularly on respective modulator elements of the modulator array 75. In this embodiment, the wedge array 81 is positioned in front of the modulator array 75 so that substantially all the light collected by the modulator lens 79 from a user station 7 passes through a single wedge prism of the wedge array. Without the wedge array 81, the principal rays of light from each user station 7 passing through the modulator lens 79 would not generally be incident perpendicularly on the modulator array 75 and therefore the modulated light reflected by the modulator array 75 would not travel back along the same path to the originating user station 7.

FIG. 11 shows in more detail the effect of the wedge array 81. As shown, the wedge array 81 comprises a plurality of wedge prisms 111_1 111_2, 111_3 which are spatially matched with corresponding modulator elements 91 of the modulator array 75 so that each wedge prism 111 is positioned adjacent to an associated modulator element 91. Each wedge prism 111 of the wedge array 81 deflects incoming rays of light by an angle which is determined by the wedge angle and the refractive index n of that wedge prism 111. As shown in FIG. 11, the principal ray of light 113_1, i.e. the ray which passes through the centre of the entrance pupil for the modulator lens 79, is incident on the wedge prism 111_2, whose wedge angle is denoted by φ at an angle θ to a line normal to the plane of the modulator array 75. As can be seen by the dotted lines in FIG. 11, if the wedge array 81 was not present then the principal ray 113_1 would be incident on the modulator element 91_2 at the angle θ to the normal and would therefore not be reflected back upon itself. The wedge angle φ is chosen to satisfy the equation:

$$φ = {tan}^{- 1} ( \frac{sin θ}{n - cos θ} ) \qquad ( 1 )$$

This relationship ensures that the principal ray 113_1 is deflected by an angle equal to θ so that the principal ray 113_1 is incident perpendicularly on the modulator element 91_2 and is reflected back upon itself by the modulator element 91_2. For a thin wedge approximation, which is generally valid, the rays apart from the principal ray will also be deflected through the angle θ and therefore, for example, the ray 113_2 will be reflected by the modulator element 91_2 along the path of the ray 113_3 and vice versa.

As the angle between the principal ray from a user station 7 and the normal to the modulator array 75 increases, the wedge angle of the corresponding wedge prism must also increase because larger deflections are required in order for the principal ray to be perpendicularly incident on the modulator array 75. Therefore, the wedge prisms located at the centre of the wedge array 81, which is positioned close to the optical axis of the modulator lens 79, have smaller wedge angles than those of the wedge prisms 111 further from the centre of the wedge array 81. For the sake of clarity, FIG. 11 shows a cross-section of the wedge array 81 and the modulator array 75 through a plane perpendicular to the modulator array 75. Those skilled in the art will appreciate that as the modulator array 75 is two-dimensional, the wedge array 81 is formed by a two-dimensional array of wedge prisms which will generally have different wedge angles in the X-direction and the Y-direction

In this embodiment, the wedge array 111 is formed by injection moulding an optical plastic material.

The detector array 77 is positioned in the back focal plane of a respective lens, hereafter called the uplink detection lens 83. As those skilled in the art will appreciate, it is not necessary for the principal rays passing through the uplink detection lens 83 to be incident perpendicular to the detector array 77. The uplink detection lens 83 is therefore designed simply to collect as much light from the user stations 7 as possible and to direct the collected light to respective detecting elements. In this embodiment, the uplink detection lens 83 is twice the size of the modulator lens 79 but has approximately the same focal length. In other words, the uplink detection lens 79 has approximately half the f-number of the modulator lens 83.

Before a user station 7 can communicate with a local distribution node 3, an initialisation procedure must be performed. A brief description of this initialisation procedure will now be given. Upon installation of a new user station 7, the installer manually aligns the user station 7 so that the laser beam output by the user station 7 is roughly directed at the local distribution node 3. The installer then sets the new user station 7 into an installation mode in which an automatic fine alignment is performed using the horizontal stepper motor 47 and vertical stepper motor 49.

The installation mode starts with the optical assembly 51 within the user station 7 positioned in the centre of the travel of the horizontal and vertical stepper motors.

The user station 7 outputs a laser beam conveying a link request signal (LRS). If the optical distribution node 3 detects the LRS, then the optical distribution node 3 transmits a reply to the user station 7. The reason why the optical distribution node 3 transmits the reply is that if the user station detects a reflected LRS, there is no guarantee that the light beam output by the user station 7 is being reflected by an optical distribution node 3 as it could be reflected back by something else within its field of view.

If the user station 7 does not detect a reply from the local distribution node.3, then the optical assembly is moved by the stepper motors in a stepwise square spiral (shown in FIG. 12) with the user station 7 checking for a reply from the local distribution node 3 after each step of the horizontal and vertical stepper motors until a reply is detected.

During the installation mode, the power of the laser beam emitted by the user station 7 is kept at an eye-safe level to avoid any possibility of serious eye damage if the laser beam is accidentally incident on a human being or animal.

In this embodiment, the beam size of the light beam incident on the local distribution node 3 must be sufficiently large to encompass at least a significant part of the modulator lens 79 and the uplink detection lens 83. This is achieved by varying the distance between the laser diode 21 and the collimating lens 25 until the required beam size at the local distribution node 3 is achieved. It is also necessary to ensure that the reflected light beam incident on the user station 7 is sufficiently large to encompass a significant part of the downlink detection lens 29. However, this will not necessarily be the case and cannot easily be corrected at the user station 7.

A second embodiment will now be described with reference to FIGS. 13A and 13B in which a reflector and a polarisation beam splitter are added to the optical assembly of the user station 7 of the first embodiment in order to align the light beam output by the user station with the optical axis of the downlink detection lens 31. The remaining components of the user station are identical to those of the first embodiment. In FIGS. 13A and 13B components which are identical to the corresponding components in the first embodiment have been referenced with the same numerals and will not be described again.

FIG. 13A shows the optical components in the user station of the second embodiment. The laser diode 21 emits a linearly-polarised light beam 23 which is passed through the collimating lens 25 to form the low divergence light beam 27. A reflector 121 is aligned at an angle of 45° to the propagation direction of the light beam 27 so that the light beam 27 is reflected through a right angle and directed to a polarisation beam splitter 123 which is aligned at 45° to the optical axis of the downlink detection lens 31. The polarisation separating surface of the polarisation beam splitter 123 reflects the linearly-polarised light from the reflector 121 so that it is directed along the optical axis of the downlink detection lens 31 away from the user station towards the local distribution node.

FIG. 13B shows the main components of the local distribution node of the second embodiment. As shown, the only difference from the local distribution node of the first embodiment is that a quarter wave plate 131 is provided in front of the modulator lens 79 (i.e. on the side of the modulator lens 79 away from the modulator array 75). As described above, the collimating lens 25 in the user station is scanned to a position where the light beam incident on the user distribution node encompasses both the modulator lens 79 and the uplink detection lens 83. Some of the light from the user station passes through the quarter-wave plate 131, which converts the linearly-polarised light to circularly-polarised light, before passing through the modulator lens 79. The circularly-polarised light is then reflected by the modulator array 75 and passed back through the modulator lens 79 and the quarter-wave plate 131 which converts the reflected circularly-polarised light into linearly-polarised light whose direction of polarisation is perpendicular to that of the light beam from the user station.

Returning to FIG. 13A, the linearly-polarised light from the local distribution node is transmitted through the polarisation separating surface of the polarisation beam splitter 123 and is then focussed by the downlink detection lens 31 onto the detector 33.

As described above, using the reflector 121 and the polarisation beam splitter 123 to steer the light beam emitted by the laser diode 21 along the optical axis of the detection lens 31, ensures that a significant portion of the retro-reflected light beam 29 from the local distribution node is incident on the downlink detection lens 31. Further, because the downlink detection lens 31 is provided between the detector 33 and the polarisation beam splitter 123, back reflections of light from the laser diode 21 off optical surfaces of the downlink detection lens 31 do not occur.

In the first and second embodiments, the modulator elements 91 of the modulator array 75 are separated by gaps. This means that there are locations within the field of view of the lens where communication between the user station and the local distribution node cannot occur reliably because they are along a direction which is mapped to a gap between the pixels. A third embodiment will now be described with reference to FIG. 14 in which the wedge prisms of the wedge array are curved to form a magnified image of the associated modulator element. In this way, the modulator array appears to have a 100% packing density when viewed from outside of the local distribution node.

FIG. 14 shows part of the wedge array and the modulator array. The remaining components of the third embodiment are identical to those of the first embodiment and will not therefore be described again.

As shown in FIG. 14, each of the wedge prisms 135_1, 135_2 and 135_3 of the wedge array has a curved surface. For each wedge prism, the line tangential to the centre of the curved surface is at an angle φ to a plane parallel to the surface of the modulator array 75. The angle φ is selected, in accordance with equation 1 above, so that the principal ray arriving at the centre of the curved surface at an angle θ to the normal of the planar surface of the modulator array 75 is deflected so as to be incident perpendicularly on the associated modulator element 91_2. The curvature of the surface of the wedge prism 135 means that the angle between the tangent to a point on the curved surface and a plane parallel to the surface of the modulator array 75 increases for points on the curved surface of the wedge prism 135 further away from the centre of the wedge array 141. Therefore, the curved surface has an associated positive optical power which forms a magnified image of the associated modulator element 91.

Further details of how the effective packing density can be increased by using an array of elements with an associated optical power can be found in International Patent Application WO 01/05069, the whole contents of which are incorporated herein by reference.

In the first to third embodiments, the user station is in a fixed position relative to the local distribution node. A fourth embodiment will now be described with reference to FIGS. 15 and 16 in which the user station is able to move relative to the local distribution node. In this embodiment, the local distribution node is identical to that of the first embodiment.

FIG. 15 schematically illustrates the main components of the local distribution node 3 and a user station of the fourth embodiment. Components which are the same as corresponding components in the first embodiment have been referenced by the same numerals and will not be described again.

As shown in FIG. 15, the interface unit 41 acts as an interface between a user device (not shown) and a central control unit 141 of the user station. Data received by the interface unit 41 from the user device is input to the central control unit which generates control signals for a laser driver 143 in accordance with the received data. The laser driver 143 generates drive signals for an emitter array 145 which in this embodiment comprises a two-dimensional pixelated planar array with a vertical cavity surface emitting laser (VCSEL) positioned at each pixel. The use of VCSELs is preferred because the emitter array 145 can then be manufactured from a single semi-conductor wafer without having to cut the wafer. This allows a higher density of laser elements than would be possible for traditional diode lasers. VCSEL arrays which output light beams having a wavelength in the region of 850 nm within the power range of between 1 mW and 30 mW are available from CSEM SA, Badenerstrasse 569, 8048 Zurich, Switzerland.

In this embodiment, the laser driver 143 is able to drive the VCSELs of the emitter array 145 individually and applies a small signal modulation in accordance with the control signals output by the central control unit 141 in order to convey uplink data from the user device to the local distribution node. The light emitted from each VCSEL is incident on a respective wedge prism of a wedge array 147. The wedge prisms of the wedge array 147 deflect the emitted light so that the ray of light emitted by a VCSEL perpendicular to the surface of the emitter array 145 is directed through the centre of the aperture stop of the collimating lens 25.

FIG. 16 shows a magnified view of the emitter array 145, wedge array 147 and collimating lens 25. As shown, the wedge prisms of the wedge array 145 are spatially matched with the VCSELs of the emitter array 145 so that each VCSEL is associated with a corresponding wedge prism. Further, in this embodiment, the wedge array 147 is positioned adjacent the emitter array 145 so that substantially all the light emitted from a VCSEL is passed through the associated wedge prism of the wedge array 147. The ray emitted perpendicularly from a VCSEL in the emitter array 145 is deflected by the associated wedge prism so that it passes through the centre of the aperture stop of the collimating lens 25. The wedge angles φ of each wedge prism in the wedge array 147 is determined using the equation (1) above, with the angle θ being the angle subtended between the line passing from the centre of the aperture stop to wedge prism and the optical axis of the collimating lens 25. Therefore, the wedge angle will increase with the distance of the wedge prism from the centre of the wedge array 147.

Using the wedge array 147 has the advantage that the collection efficiency by the collimating lens 25 of light from each of the VCSELs in the emitter array 147 is approximately constant and therefore the intensity of the light output from the user station will be the same for each of the VCSELs. In contrast, with a conventional collimating lens the intensity of the light output will be greater for light emitted by VCSELs at the centre of the VCSEL array than light emitted by VCSELs at the edge of the emitter array 145.

The modulated light received from the local distribution node is collected by the downlink detection lens 31 and directed to a light detecting element of a detector array 149. In this embodiment, the detector array 149 is a two dimensional array of photodiodes. Each of the detecting elements of the detector array 149 converts incident light into a corresponding electrical signal which is input to a detection circuit 151 which amplifies and filters the electrical signal, and the filtered signals are input to a central control unit 141. The central control unit 141 regenerates data transmitted from the local distribution node from the filtered signals and sends the data to the user device via the interface unit 41.

As described in International Patent Application WO 00/48338, the whole contents which are hereby incorporated by reference, the direction of the local distribution node relative to the user station will determine which of the detecting elements in the detector array 149 detects the modulated light from the local distribution node. Therefore, a tracking operation can be performed in which the VCSEL in the emitter array 145 used to output the light beam to the local distribution node is selected in accordance with which of the detecting elements of the detector array 149 detects the light returned from the local distribution node.

### Modifications and Further Embodiments

In the illustrated embodiments, a wedge array is formed using a plurality of wedge prisms which are spatially matched to an array of optical elements. The wedge angle of the wedge prisms is varied in accordance with their position within the wedge array so that the wedge array and a standard lens (which is not telecentric) together approximate a telecentric lens.

Although the wedge array of the described embodiments is made by injection moulding an optical plasic, those skilled in the art will appreciate that other manufacturing techniques could be used.

In the third embodiment, an optical surface of the wedge prisms is curved in order to provide a positive optical power which magnifies the size of the associated modulator element in order to improve the effective packing density of the modulator elements. The curved surface could also be aspheric to correct for astigmatic or other optical aberrations. Those skilled in the art will appreciate that wedge prisms with curved surfaces could also be used with the emitter array.

In the described embodiments, the light beams are deflected by the wedge prisms due to refraction. Those skilled in the art will appreciate that a planar structure having a varying refractive index distribution could be provided in order to provide the refractive effect instead of the wedge prisms having a constant refractive index. The refractive index distribution of the planar structure could be arranged so that each refracting element has an associated positive optical power, and the refractive index distribution could also correct for astigmatic aberration. Further, it is not necessary to use refraction to obtain the beam deflection. For example, a diffractive optical element (such as a hologram) could be used or even an array of reflectors could be used.

In the described embodiments, separate optical systems are provided in the user station for the light emitter and the light detector to reduce back reflections falling on the light detector. Those skilled in the art will appreciate that the wedge array (or equivalent structures) could also be used in systems in which a beam splitter is used to optically align the optical axes of the collimating lens and the downlink detection lens, such as those described in WO 98/35328 and WO 00/48338, in order to approximate a telecentric optical system.

In the second embodiment, a beam steering arrangement is formed by the reflector 121 and polarisation beam splitter 123 to align the light beam emitted by the user station along the optical axis of the lens system for the detector.

As described above, providing separate optical systems for the light emitter and the light detector in the user station and for the modulator array and light detector in the local distribution node enables the lens systems to be separately optimised in accordance with their associated optical element. The particular details provided in the described embodiment are given for exemplary purposes only and are not essential to the invention.

Those skilled in the art will appreciate that the wedge array is not essential for the advantages associated with separating the optical systems. For example, the modulator array and the wedge array could be replaced by a telecentric lens with the modulator array being positioned substantially within the back focal plane of the telecentric lens.

In the first embodiment, the light emitter and the light detector are mounted along with their associated optical systems as a single optical assembly which is moved by stepper motors in order to steer the emitted light beam. Alternatively, the light emitter and associated lens system could be mounted separately from the light detector and associated lens system. The beam steering techniques described in WO 01/05072, the whole contents of which is incorporated herein by reference, could also be used. In another embodiment, the light beam could be steered by moving a lens element forming part of the lens for the emitter.

Those skilled in the art will appreciate that if the direction of the emitted light beam is varied then the return light beam will not generally be focussed at the centre of the detection surface of the detector. However, if the detection surface is much larger than the focussed spot size, as in the first embodiment, this is not a problem. Those skilled in the art will also appreciate that for the arrangement in the first embodiment, it is not essential for the detection surface to be much larger than the focussed spot size because when the direction of the emitted light beam is varied, the optical axis of the detection lens is moved to match the direction of the emitted light beam.

In the described embodiments, light beams from a plurality of user stations are incident on respective modulator elements of a modulator array in a local distribution node and are retro-reflected back to their originating user stations. Alternatively, a plurality of light emitters could be provided in the local distribution node and modulators provided in each of the user stations.

In the first to third embodiments, QCSE modulators are used. As those skilled in the art will appreciate, other types of reflectors and modulators could be used. For example, a plane mirror may be used as the reflector and a transmissive modulator (such as liquid crystal) could be provided between the lens and the mirror. Further, those skilled in the art will appreciate that the reflectors and/or modulators need not be integrated in a single device and it is also not essential for the reflectors and/or modulators to be located in a common plane, although these features are preferred for ease of device manufacture and alignment.

In the first to third embodiments, the modulator elements are arranged in a rectangular matrix. However, this is not essential and the modulator elements could be arranged in a different form of regular array or even in an irregular arrangement.

In the fourth embodiment, a VCSEL array is used. As those skilled in the art will appreciate, other forms of light emitter could be used. For example, conventional laser diodes could be used.

In the first to fourth embodiments, full duplex transmission systems are described. Alternatively, a simplex transmission system could be used in which an unmodulated light beam is sent to a retro-reflector where it is modulated and reflected back to be detected by a detector. Alternatively, a half-duplex system could be used in which either the user station sends an unmodulated light beam to the local distribution node where it is modulated and reflected back to the user station to convey data in one direction, or modulated data is emitted by the user station to convey data to the local distribution node. In this case, the QCSE modulators could also be used to detect the modulator light beams from the user station.

Those skilled in the art will appreciate that the term light includes electromagnetic waves in the ultra-violet and infra-red regions of the electromagnetic spectrum as well as the visible region. Although the embodiments described above have used laser beams with a wavelength of about 850 nm, other wavelengths could be used. In particular, a wavelength of 1.5 μm is an attractive alternative because it is inherently more eye-safe and cheap emitters and detectors have been developed for this wavelength for optical fibre communications.

Although the lenses in the user station and the local distribution node have been schematically represented by a single lens, it will appreciate that in practice each lens may have a plurality of lens elements.

1. An optical device comprising: a lens; a plurality of optical elements; and means for deflecting light beams provided in an optical path between the lens and the plurality of optical elements,
wherein said beam deflecting means comprises a plurality of beam deflecting elements with each beam deflecting element being associated with a respective optical element and being operable to deflect a principal light ray passing through the lens so that the principal light ray is substantially perpendicular to the associated optical element.

2. An optical device according to claim 1, wherein each of the optical elements is substantially planar.

3. An optical device according to claim 2, wherein the plurality of optical elements are substantially located within a common plane.

4. An optical device according to claim 3, wherein the plurality of optical elements are integrated in a single device

5. An optical device according any preceding claim, wherein the plurality of beam deflecting elements are substantially located within a common plane.

6. An optical device according to claim 5, wherein the plurality of beam deflecting elements are integrated in a single device.

7. An optical device according to any preceding claim, wherein the plurality of optical elements are arranged in a regular array.

8. A optical device according to any preceding claim, wherein the plurality of optical elements are arranged in a rectangular matrix.

9. An optical device according to any preceding claim, wherein the spatial arrangement of the plurality of beam deflecting elements spatially matches the spatial arrangement of the plurality of optical elements.

10. An optical device according to any preceding claim, wherein each optical element comprises a reflecting element.

11. An optical device according to claim 10, further comprising means for applying a signal operable to vary the reflectivity of the reflecting elements.

12. An optical device according to claim 11, wherein the signal applying means is operable to address the reflecting elements individually.

13. An optical device according to any of claims 10 to 12, wherein each of the plurality of beam deflecting elements is positioned adjacent the associated reflecting element.

14. An optical device according to any preceding claim, wherein the plurality of optical elements comprise at least one Quantum Confined Stark Effect devices.

15. An optical device according to any of claims 1 to 9, wherein the plurality of optical elements comprise a plurality of light emitters, each light emitter being operable to emit a light beam.

16. An optical device according to claim 15, wherein at least one of said plurality of light emitters comprise a vertical cavity surface emitting laser.

17. An optical device according to claim 15 or 16, wherein each of the plurality of beam deflecting elements is positioned adjacent the associated light emitter so that substantially all the light emitted by the light emitter is incident on the associated optical element.

18. An optical device according to any preceding claim, wherein at least one of the beam deflecting elements comprises a refractive element.

19. An optical device according to claim 18, wherein said at least one refractive element comprises a wedge prism.

20. An optical device according to claim 19, wherein a surface of the wedge prism is curved so that the wedge prism has an associated optical power.

21. An optical device according to claim 20, wherein said associated optical power is positive.

22. An optical device according to claim 20 or 21, wherein the curved surface of the wedge prism is arranged to correct for aberration caused by at least one of the lens and the wedge array.

23. An optical device according to claim 18, wherein said at least one refractive element is formed by a planar layer having a variable refractive index distribution.

24. An optical device according to claim 23, wherein said at least one refractive element has a refractive index distribution which provides optical power.

25. An optical device according to claim 24, wherein said associated optical power is positive.

26. An optical device according to claim 24 or 25, wherein the refractive index distribution is operable to correct for aberration caused by at least one of the lens and the wedge array.

27. An optical device according to any of claims 1 to 15, wherein at least one of the beam deflecting elements comprises a diffractive element.

28. An optical device according to any of claims 1 to 15, wherein at least one of the beam deflecting elements comprises a reflective element.

29. An optical device comprising: a lens; a plurality of optical elements; and means for deflecting light beams provided in an optical path between the lens and the plurality of optical elements,
wherein said beam deflecting means comprises a plurality of beam deflecting elements with each beam deflecting element being associated with a respective optical element and being operable to deflect a principal light ray passing through the lens at an angle oblique to the optical axis of the lens so that the principal light ray is optically parallel with the optical axis of the lens.

30. An optical device comprising: a lens; a modulator array having a plurality of modulator elements; and means for deflecting light beams provided in an optical path between the lens and the modulator array,
wherein said beam deflecting means comprises a plurality of beam deflecting elements with each beam deflecting element being associated with a respective modulator element and being operable to deflect a principal light ray passing through the lens so that the principal light ray is incident perpendicular to the associated modulator element.

31. A signalling system comprising first and second signalling devices,
the first signalling device comprising: means for emitting a light beam; means for directing the emitted light beam at the second signalling device; means for receiving a modulated light beam from the second signalling device; and means for retrieving a data signal from the modulated light beam, and
the second signalling device comprising an optical device according to claim 30, wherein the emitted light beam from the first signalling device is incident perpendicular to a modulator element of the modulator array which modulates the emitted light beam in accordance with said data signal to generate said modulated light beam and reflects the modulated light beam back to the first signalling device.

32. An optical device comprising: a lens; an emitter array having a plurality of light emitting elements; and means for deflecting light beams provided in an optical path between the lens and the emitter array,
wherein said beam deflecting means comprises a plurality of beam deflecting elements with each beam deflecting element being associated with a respective light emitting element and being operable to deflect a light ray emitted perpendicularly by the light emitting element so that the perpendicular light ray passes through the lens along the path of a principal light ray.

33. A signalling system comprising first and second signalling devices,
the first signalling device comprising an optical Lo device according to claim 32, wherein each of the plurality of emitters of the first signalling device is operable to emit a respective light beam carrying information; and
the second signalling device comprising: i) a lens system for collecting light emitted from a light emitter of said first signalling device; ii) a light detector for receiving the collected light from said lens system and for converting the received light into corresponding electrical signals; and iii) means for processing the electrical signals from said light detector to retrieve said information.

34. A free-space optical signalling system comprising first and second signalling devices,
the first signalling device comprising: means for emitting a light beam; means for directing the emitted light beam at the second signalling device; means for receiving a modulated light beam from the second signalling device; an opto-electric converter for converting the received modulated light beam into a corresponding electrical signal; and means for retrieving a data signal from said corresponding electrical signal, and
the second signalling device comprising: means for receiving the emitted light beam from the first signalling device; means for modulating the received light beam in accordance with said data signal; and means for retro-reflecting the modulated light beam back to the first signalling device,
wherein said directing means of the first signalling device comprises a first lens system and the receiving means of the first signalling device comprises a second lens system separate from the first lens system.

35. A signalling system according to claim 34, wherein the first and second lens systems have first and second optical axes respectively, and the first and second lens systems are positioned such that the first and second optical axes are not co-aligned.

36. A free-space optical signalling system comprising first and second signalling devices,
the first signalling device comprising: means for emitting a light beam; means for directing the emitted go light beam at the second signalling device; means for receiving a modulated light beam from the second signalling device; an opto-electric converter for converting the received modulated light beam into a corresponding electrical signal; and means for retrieving a data signal from said corresponding electrical signal, and
the second signalling device comprising: means for receiving the emitted light beam from the first signalling device; means for modulating the received light beam in accordance with said data signal; and means for retro-reflecting the modulated light beam back to the first signalling device,
wherein said directing means of the first signalling device comprises a first lens system and beam steering means and the receiving means of the first signalling device comprises a second lens system separate from the first lens system,
and wherein the first lens system is arranged so that light emitted by the emitting means passes through the first lens system and onto the beam steering means, and the beam steering means is arranged to steer the emitted light beam along the optical axis of the second lens system directly to the second signalling device without passing through the second lens system.

37. A signalling system according to claim 36, wherein the beam steering means comprises a beam splitter and the second lens system is optically located between the beam combiner and the opto-electric converter.

38. A signalling system according to any of claims 34 to 37, wherein the first signalling device further comprises means for modulating the light beam emitted by the light emitter in accordance with a message to be sent from the first signalling device to the second signalling device,
and wherein the second signalling device further comprises: an opto-electric converter for detecting the emitted light beam and converting the emitted light beam into a corresponding electrical signal; means for directing at least part of the emitted light beam onto the opto-electric converter; and means for recovering the message from the corresponding electrical signal.

39. A signalling system according to claim 38, wherein the modulating means of the first signalling device is arranged to apply a small signal modulation to the emitted light beam.

40. A signalling system according to claim 38 or 39, wherein said directing means of the second signalling device comprises a third lens system and the receiving means of the second signalling device comprises a fourth lens system separate from the third lens system.

41. A signalling system according to claim 40, wherein the third and fourth lens systems have third and fourth optical axes respectively, and the third and fourth lens systems are positioned such that the third and fourth optical axes are not co-aligned.
